(19) United States
(12) Patent Application Publication
(10) Pub. No.: US 2024/0019774 A1
(43) Pub. Date: Jan. 18, 2024

(54) RETRACTABLE REAR PROJECTION DOME

(71) Applicant: CAE INC., Saint-Laurent (CA)

(72) Inventors: Andrew GILLESPIE, Saint-Laurent (CA); Felice SALVADORE, Saint-Laurent (CA)

(21) Appl. No.: 18/253,207

(22) PCT Filed: Nov. 16, 2021
(86) PCT No.: PCT/CA2021/051624

§ 371 Date: May 17, 2023

Related U.S. Application Data
(60) Provisional application No. 63/114,572, filed on Nov. 17, 2020.

(51) Int. Cl. G03B 21/58

(52) U.S. Cl. CPC G03B 21/58

(57) ABSTRACT

A rear projection dome (10) including: a front screen section (12) defining an upper front edge (14) and opposite side front edges (16,18); a rear screen section (20) defining an upper rear edge (22) and opposite side rear edges (24, 26). The opposite side front edges (16, 18) and the opposite side rear edges (24, 26) form seamless side joints (28) for allowing uninterrupted projections between the front screen section (12) and the rear screen section (20). A top screen section (30) defines a top peripheral edge (32) configured to be mounted to the upper front edge (14) of the front screen section (12). A peripheral top edge (32) of the top screen section (30) and the upper front edge (14) define a conical joint interface (34) for allowing uninterrupted projections between the front screen section (12) and the top screen section (30).

### FIELD OF THE INVENTION

The present invention relates to a rear projection dome system. In particular, the present application relates to a rear projector dome system used in a simulator.

### BACKGROUND TO THE INVENTION

Domed imaging systems are known and used for both entertainment and simulator training. They can be used in vehicle simulators such as flight simulators developed to provide a realistic analogue of the vehicle being simulated without the dangers inherent in having such a vehicle operated by a novice or under extreme conditions. As the realism of the simulators has improved, they have become an indispensable component in the certification of vehicle operators such as pilots. In order to ensure that a given simulator meets the requisite realism such that it can be used as part of a certification program, the operation of various components must be measured versus a preapproved certification standard and, as necessary, recalibrated.

Domed imaging systems use a plurality of projectors to project images on the internal or external surface of a dome, the surface effectively serving as a screen. Systems configured to project images on the internal surface of a dome are known as front projection systems while those configured to project images on the external surface of a dome are known as rear projection systems.

Domed imaging systems used in flight simulators can have domes of unitary construction configured to receive simulated cockpits through a floor opening. Alternatively, they can have domes assembled from multiple screen sections using clamping mechanisms designed to minimize seams between screen sections. The clamping mechanisms have to be carefully mounted to avoid creating shadows on the screen. Removal of a cockpit from a multi-section dome may require disassembly of the dome.

### SUMMARY OF THE INVENTION

There is provided a rear projection dome, comprising: a front screen section defining an upper front edge and opposite side front edges; a rear screen section defining an upper rear edge and opposite side rear edges, wherein, when the top screen section is mounted onto the front screen section, the peripheral top edge of the top screen section and the upper front edge of the front screen section define a conical joint interface for allowing uninterrupted projections between the front screen section and the top screen section.

In embodiments, the rear screen section is configured to be moved between an open position and a closed position, wherein in the open position the rear screen section is spaced apart from the front screen section for allowing a user to penetrate inside the dome, and wherein in the closed position the opposite side front edges of the front screen section and the opposite side rear edges of the rear screen section form seamless side joints for allowing uninterrupted projections between the front screen section and the rear screen section; and a top screen section defining a top peripheral edge configured to be mounted to the upper front edge of the front screen section.

In embodiments, the top peripheral edge of the top screen section is configured to be mounted to the upper rear edge of the rear screen section, and wherein, when the top screen section is mounted onto the rear screen section, the peripheral top edge of the top screen section and the upper rear edge of the rear screen section define a conical joint interface for allowing uninterrupted projections between the rear screen section and the top screen section.

In embodiments, the front screen section and rear screen section respectively define cutouts for accommodating a cockpit.

In embodiments, a frame structure is used for supporting the rear screen section, the frame structure being configured to move the rear screen section between the open and closed positions.

In embodiments, a top flange extends from the peripheral top edge of the top screen section; and a lower flange extends from the upper front edge of the front screen section; wherein the peripheral top edge of the top screen section and the upper front edge of the front screen section that define the conical joint interface are connectable together via a connection of the top flange and lower flange.

In embodiments, a top flange extends from the peripheral top edge of the top screen section; a lower flange extends from the upper rear edge of the rear screen section; wherein the peripheral top edge of the top screen section and the upper rear edge of the rear screen section that define the conical joint interface are connectable together via a connection of the top flange and the lower flange.

In embodiments, an upper flange extends from the peripheral top edge of the top screen section; a housing is configured for adjustable connection to the upper flange; and an elongate member has a bottom end pivotally connectable to a top end of the housing, the elongate member having a top end pivotally connectable to an overhead frame for operatively holding the top screen section.

In embodiments, the lower flange extends continuously along the upper front edge of the front screen section.

According to the present invention, there is also provided a rear projection dome system, comprising: a plurality of projectors; a front screen section defining an upper front edge and opposite side front edges; a rear screen section defining an upper rear edge and opposite side rear edges, wherein, when the top screen section is mounted onto the front screen section, the peripheral top edge of the top screen section and the upper front edge of the front screen section define a conical joint interface for allowing uninterrupted projections between the front screen section and the top screen section.

In embodiments, the rear screen section is configured to be moved between an open position and a closed position, wherein in the open position the rear screen section is spaced apart from the front screen section for allowing a user to penetrate inside the dome, and wherein in the closed position the opposite side front edges of the front screen section and the opposite side rear edges of the rear screen section form seamless side joints for allowing uninterrupted projections between the front screen section and the rear screen section; and a top screen section defining a top peripheral edge configured to be mounted to the upper front edge of the front screen section; wherein, in operation, the projectors cast images on the screen sections.

In embodiments of the system, the top peripheral edge of the top screen section is configured to be mounted to the upper rear edge of the rear screen section, and wherein, when the top screen section is mounted onto the rear screen section, the peripheral top edge of the top screen section and the upper rear edge of the rear screen section define a conical joint interface for allowing uninterrupted projections between the rear screen section and the top screen section.

According to the present invention, there is also provided a method for operating a rear projection dome having a front screen section and a rear screen section, the method comprising: projecting projections that overlap between the front screen section and the rear screen section, wherein in opposite side front edges of the front screen section and opposite side rear edges of the rear screen section form seamless side joints for allowing uninterrupted projections between the front screen section and the rear screen section.

In embodiments, the method comprises moving the rear screen section between an open position and a closed position, wherein in the open position the rear screen section is spaced apart from the front screen section for allowing a user to penetrate inside the dome, and wherein in the closed position opposite side front edges of the front screen section and opposite side rear edges of the rear screen section form seamless side joints for allowing uninterrupted projections between the front screen section and the rear screen section.

In embodiments, the method further comprises installing in place said front screen section defining an upper front edge and said opposite side front edges; and installing in place said rear screen section defining an upper rear edge and said opposite side rear edges.

In embodiments, the method further comprises: installing in place said front screen section defining an upper front edge and said opposite side front edges; and installing in place said rear screen section defining an upper rear edge and said opposite side rear edges.

In embodiments, the method further comprises: mounting a top screen section onto the front screen section, the top screen section defining a top peripheral edge configured to be mounted to the upper front edge of the front screen section, the peripheral top edge of the top screen section and the upper front edge of the front screen section defining a conical joint interface for allowing uninterrupted projections between the front screen section and the top screen section.

In embodiments, the method further comprises: projecting images on said screen sections by means of a plurality of projectors.

### BRIEF DESCRIPTION OF THE DRAWINGS

FIG. 1A is a perspective rear top view of a rear projection dome in a closed position, in accordance with an illustrative embodiment of the present invention.

FIG. 1B is a perspective rear top view of the rear projection dome in an open position, in accordance with an illustrative embodiment of the present invention.

FIG. 2A is a side elevation view of the rear projection dome in the closed position shown in FIG. 1A, in accordance with an illustrative embodiment of the present invention.

FIG. 2B is a side elevation view of the rear projection dome in the open position, in accordance with an illustrative embodiment of the present invention.

FIG. 3A is a top plan view of the rear projection dome in the closed position shown in FIG. 2A, in accordance with an illustrative embodiment of the present invention.

FIG. 3B is a top plan view of the rear projection dome in the open position shown in FIG. 2B, in accordance with an illustrative embodiment of the present invention.

FIG. 4 is a side sectional enlarged view of circle A shown in FIG. 2A, wherein the top screen section is mounted on the front screen section of the dome, in accordance with an illustrative embodiment of the present invention.

FIG. 5 is a side sectional enlarged view along line GG-GG shown in FIG. 3A, in accordance with illustrative embodiments of the present invention.

FIG. 6 is a side sectional enlarged view of circle B shown in FIG. 2A, wherein the top screen section is mounted on the rear screen section of the dome, in accordance with an illustrative embodiment of the present invention.

FIG. 7 is a side sectional enlarged view of a portion of the dome shown in FIG. 1A, wherein the top screen section is mounted on the rear screen section of the dome, in accordance with an illustrative embodiment of the present invention.

FIG. 8 is a side sectional enlarged view of circle C shown in FIG. 3A, wherein the front screen section is adjacent the rear screen section of the dome shown in FIG. 2A, in accordance with an illustrative embodiment of the present invention.

FIG. 9 is a perspective view of a flange and support hardware of the dome shown in FIG. 1A, in accordance with an illustrative embodiment of the present invention.

FIG. 10 is a perspective top rear view of a rear projection dome in a closed position, in accordance with another illustrative embodiment of the present invention.

FIG. 11 is a side elevation view of the rear projection dome in the closed position shown in FIG. 10, in accordance with another illustrative embodiment of the present invention.

FIG. 12 is a front elevation view of the rear projection dome in the closed position shown in FIG. 10, in accordance with another illustrative embodiment of the present invention.

FIG. 13 is a rear elevation view of the rear projection dome in the closed position shown in FIG. 10, in accordance with another illustrative embodiment of the present invention.

FIG. 14 is a top plan view of the rear projection dome in the closed position shown in FIG. 10, in accordance with another illustrative embodiment of the present invention.

FIG. 15 is a bottom view of the rear projection dome in the closed position shown in FIG. 10, in accordance with another illustrative embodiment of the present invention.

FIG. 16 is a perspective top rear view of a rear projection dome in an open position, in accordance with another illustrative embodiment of the present invention.

FIG. 17 is a side elevation view of the rear projection dome in the open position shown in FIG. 16, in accordance with another illustrative embodiment of the present invention.

FIG. 18 is a front elevation view of the rear projection dome in the open position shown in FIG. 16, in accordance with another illustrative embodiment of the present invention. [0044] [0029] FIG. 19 is a rear elevation view of the rear projection dome in the open position shown in FIG. 16, in accordance with another illustrative embodiment of the present invention.

FIG. 20 is a top plan view of the rear projection dome in the open position shown in FIG. 16, in accordance with another illustrative embodiment of the present invention.

FIG. 21 is a bottom view of the rear projection dome in the open position shown in FIG. 16, in accordance with another illustrative embodiment of the present invention.

FIG. 22 is a block diagram of a method of operating a rear projection dome, according to a preferred embodiment of the present invention.

### DETAILED DESCRIPTION OF THE ILLUSTRATIVE EMBODIMENTS

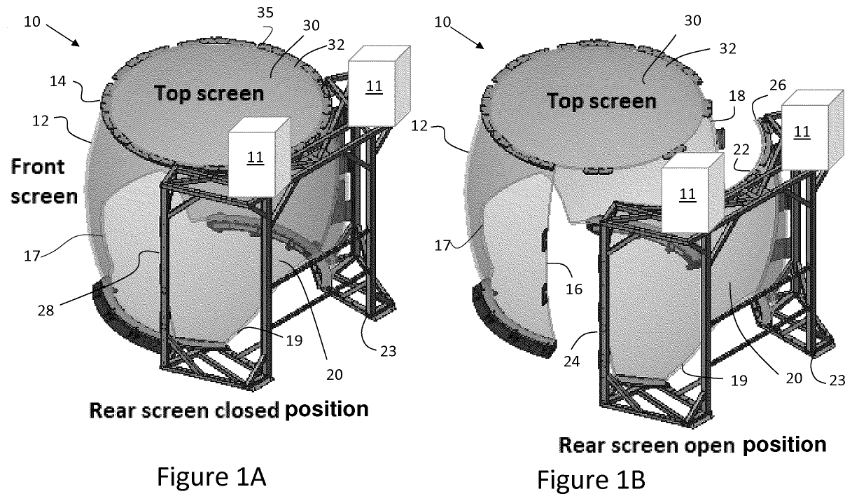

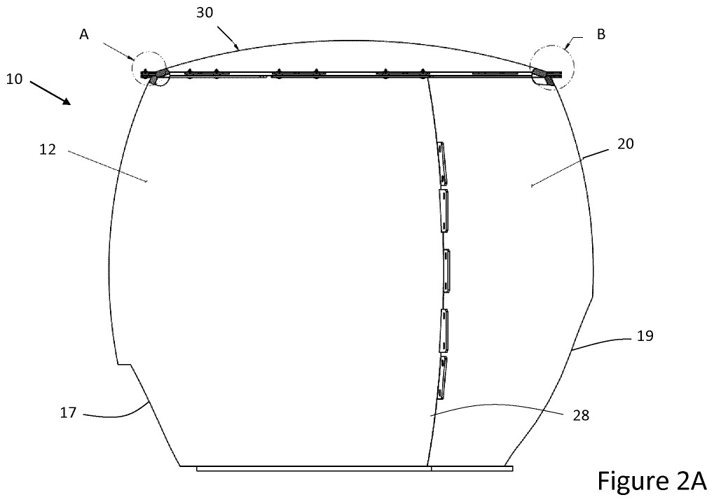

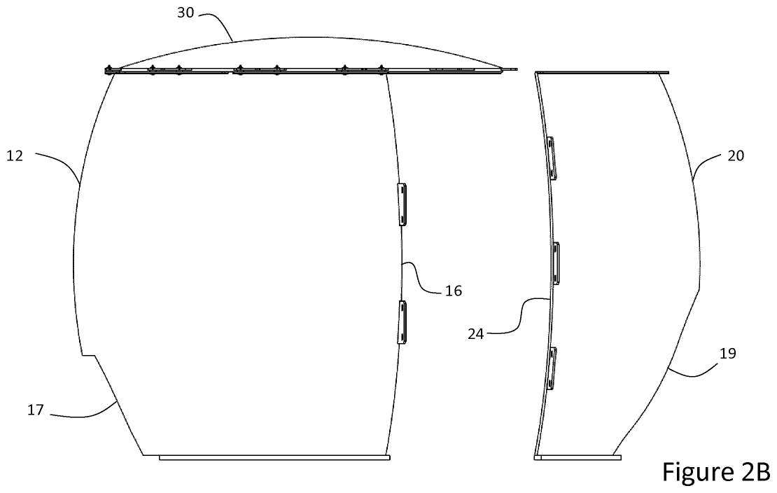

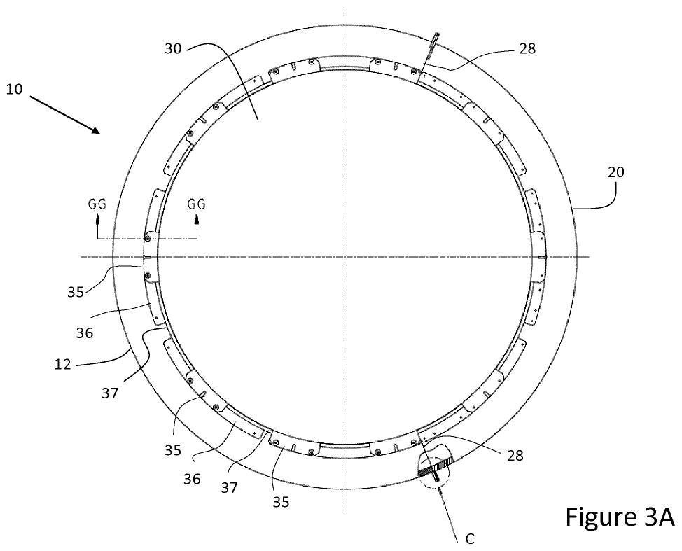

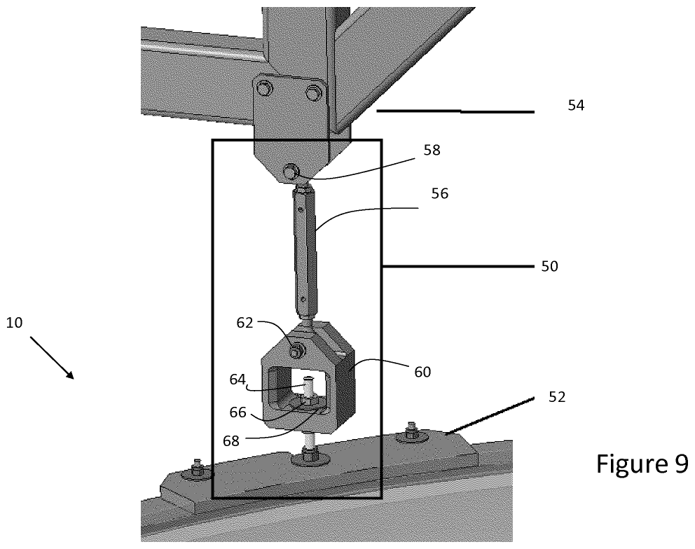

Referring now to FIGS. 1A and 1B, there is shown an embodiment of a rear projection dome 10 in respectively closed and open positions, according to an embodiment of the present invention. The dome 10 includes a front screen section 12 defining an upper front edge 14 and opposite side front edges 16 and 18. The dome 10 includes a rear screen section 20 defining an upper rear edge 22 and opposite side rear edges 24 and 26. The dome 10 may include a plurality of projectors 11. In use, the rear screen section 20 is configured to be moved between a closed position, as shown in FIG. 1A, and an open position, as shown in FIG. 1B. In the open position, shown in FIGS. 1B, 2B and 3B, the rear screen section 20 is spaced apart from the front screen section 12 for allowing a user to penetrate inside the dome 10. In the closed position, shown in FIGS. 1A, 2A, 3A, and 8, the opposite side front edges 16 and 18 of the front screen section 12 and the opposite side rear edges 24 and 26 of the rear screen section 20 form seamless side joints 28 for allowing uninterrupted projections between the front screen section 12 and the rear screen section 20.

In embodiments, the from screen section 12 and rear screen sections 20 respectively define cutouts 17, 19 located at the bottom thereof for accommodating a cockpit (not shown).

In embodiments, a frame structure 23 is used for supporting the rear screen section 20. The frame structure 23 is configured to move the rear screen section 20 between the open and closed positions.

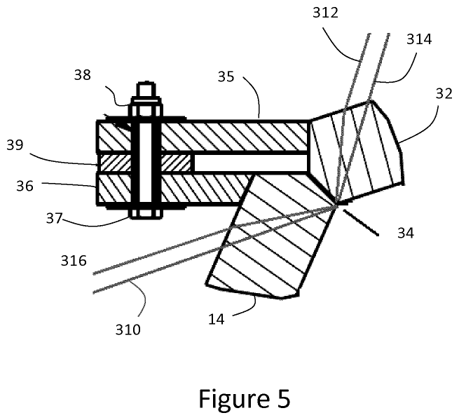

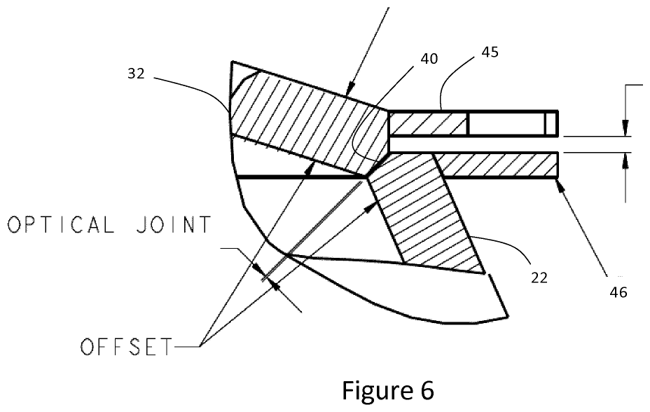

Referring now to FIGS. 4 and 5, in addition to FIGS. 1A to 3B, the dome 10 includes a top screen section 30 defining a top peripheral edge 32 configured to be mounted to the upper front edge 14 of the front screen section 12. When the top screen section 30 is mounted onto the front screen section 12, the peripheral top edge 32 of the top screen section 30 and the upper front edge 14 of the front screen section 12 define a conical joint interface 34 for allowing uninterrupted projections between the front screen section 12 and the top screen section 30.

In embodiments, the peripheral top edge 32 of the top screen section 30 and the upper front edge 14 of the front screen section 12 that define the conical joint interface 34 are connected together via a top flange 35 extending from the peripheral top edge 32 of the top screen section 30 and via a lower flange 36 extending from the upper front edge 14 of the front screen section 12. A screw 37 and nut 38 with a spacer 39 ensure proper connection between flanges 35 and 36.

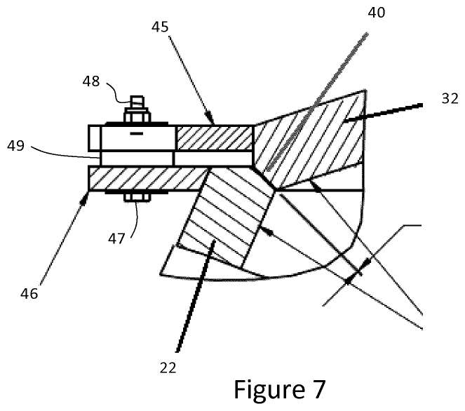

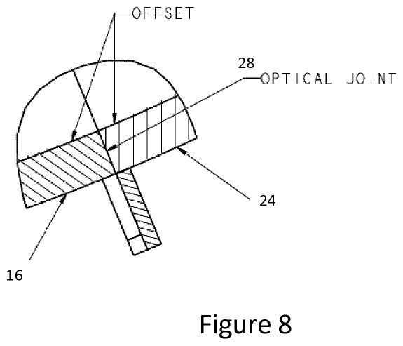

Referring now to FIGS. 6 and 7, in addition to FIGS. 1A to 3B, the top peripheral edge 32 of the top screen section 30 is configured to be mounted to the upper rear edge 22 of the rear screen section 20. Thereby, when the top screen section 30 is mounted onto the rear screen section 20, the peripheral top edge 32 of the top screen section 30 and the upper rear edge 22 of the rear screen section 20 define a conical joint interface 40 for allowing uninterrupted projections between the rear screen section 20 and the top screen section 30.

In embodiments, the peripheral top edge 32 of the top screen section 30 and the upper rear edge 22 of the rear screen section 20 that define the conical joint interface 40 are connected together via a top flange 45 extending from the peripheral top edge 32 of the top screen section 30 and via a lower flange 46 extending from the upper rear edge 22 of the rear screen section 20. A screw 47 and nut 48 with a spacer 49 ensure proper connection between the flanges 45 and 46.

In embodiments, the front screen section 12, the rear screen section 20 and the top screen section 30 are made of a 1.3″-1.4″ thick optical grade acrylic material, which enables the use of the conical joint interfaces 34 and 40 between the front, rear and top dome sections 12, 20, 30. This arrangement accommodates the required image clearances (including the refraction index) and allows the use of relatively thicker connecting flanges 35, 36, 45, 46. The flanges 35, 36, 45, 46 may be also made of acrylic and bonded to the main optical screens.

Referring back to FIGS. 4 to 7, the conical joint configuration provides self-alignment and minimum thickness joints interfaces 34, 40 as observed from the dome center pilot eye point (PEP), while allowing more offset to facilitate fabrication and assembly tolerances.

Referring back to FIG. 4, the joint interface 34 defines a gap that in turn defines an optical joint 300 toward the dome center pilot eye point with an offset 302 that decreases with an increase of the gap as shown in Table 1. In practice, the nominal gap may be 0.03″ and the maximum gap 0.08″.

Referring back to FIG. 5, there is shown the refraction of an image at the horizontal joint interface 34. A direct image 310 that goes through the upper front edge 14 reaches joint interface 34 and creates a refracted image 312 going through the peripheral top edge 32. Similarly, a direct image 314 that goes through the peripheral top edge 32 reaches joint interface 34 and creates a refracted image 316 going through the upper front edge 14.

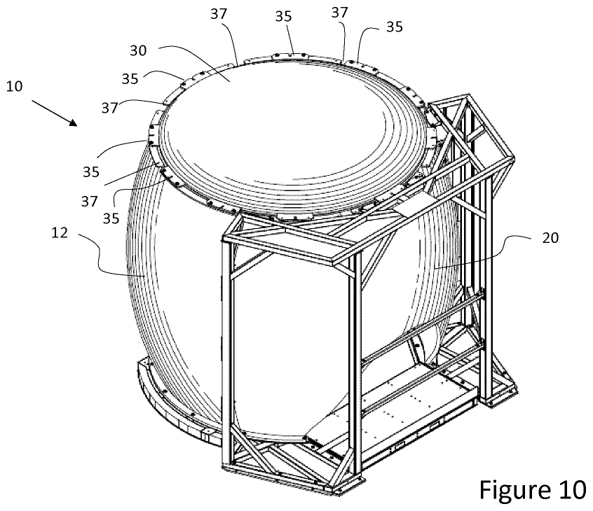

Referring now to FIG. 9, in addition to FIGS. 1A to 3A, there is shown a flange and support connecting hardware 50 for the dome 10, according to a preferred embodiment of the present invention. The upper flanges 52 provide an interface to overhead supporting frames 54. The overhead frames 54 and connecting hardware 50 structurally support the dome 10 to reduce the natural material deflection (sag) and to adjust the dome 10 to the optimum shape and joint alignment. The connecting hardware 50 includes an upper link or bar or elongate member 56 pivotally connectable at a first end to the supporting frame 54 at pivot 58. The bar 56 is pivotally connected at a second end to a housing 60 via top pivot 62. The housing 60 is adjustably connected to the upper flange 52 via a threaded screw 64 and nut 66 with washer that are accessible via a window or opening 68 of the housing 60. The adjustable connection achieved by the threaded screw 64 and nut 66 with washer allows to adjust a tension between the housing 60 and the upper flange 52. Another nut 70 with washer enables the connection of the housing 60 to the upper flange 52. As persons skilled in the art will understand, other connecting hardware may be used to achieve the function of reducing the natural material deflection (sag) by adjusting the dome 10 to the optimum shape and joint alignment.

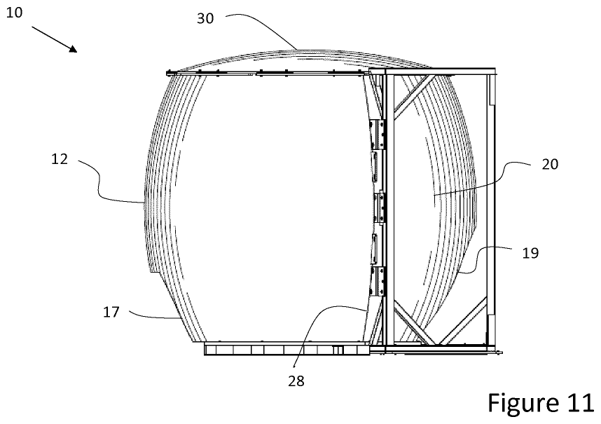

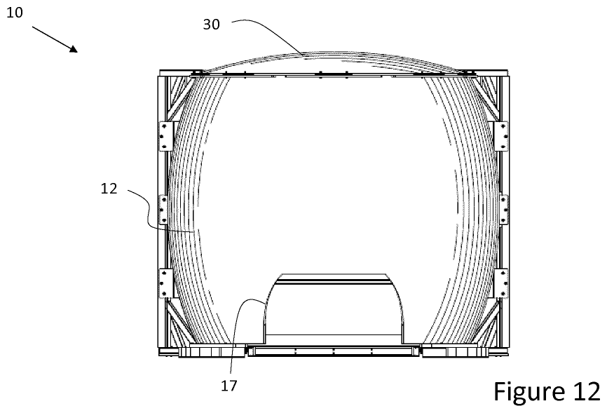

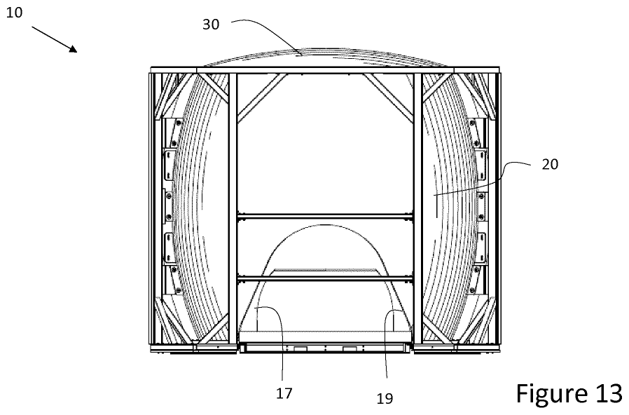

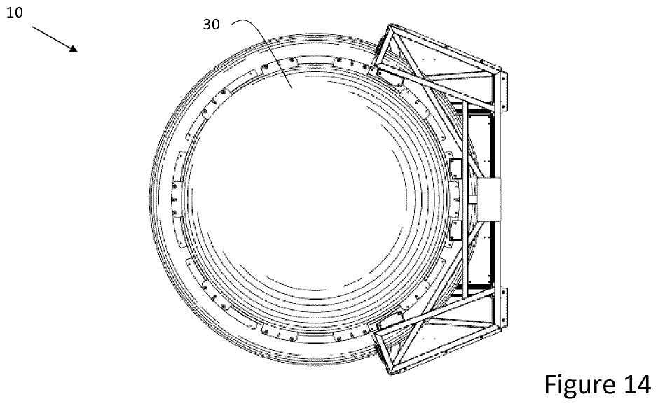

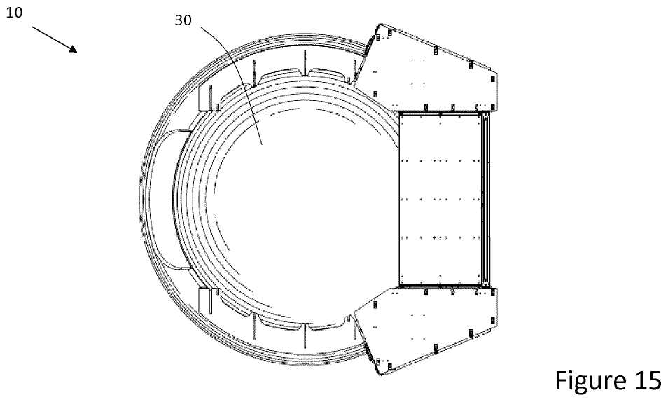

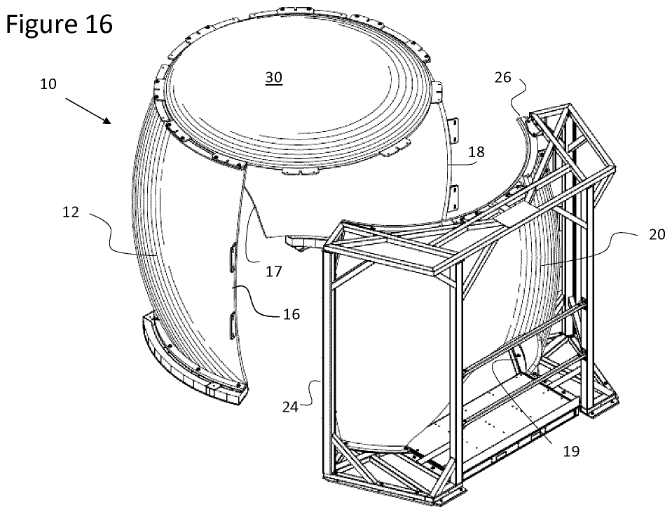

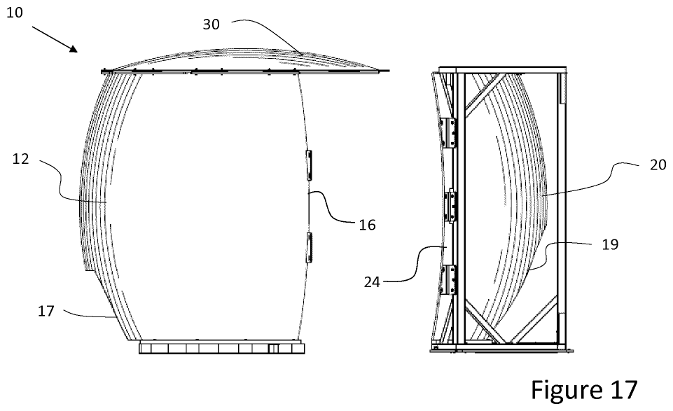

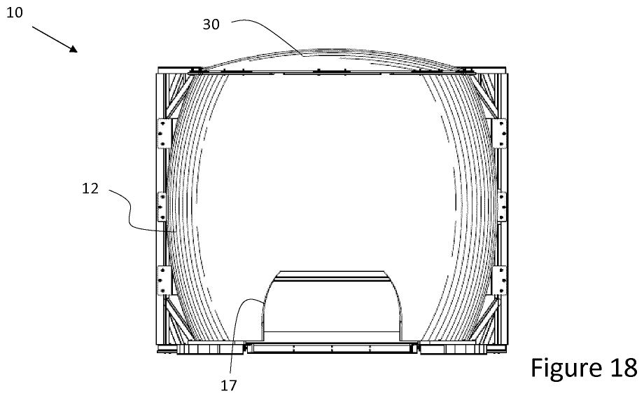

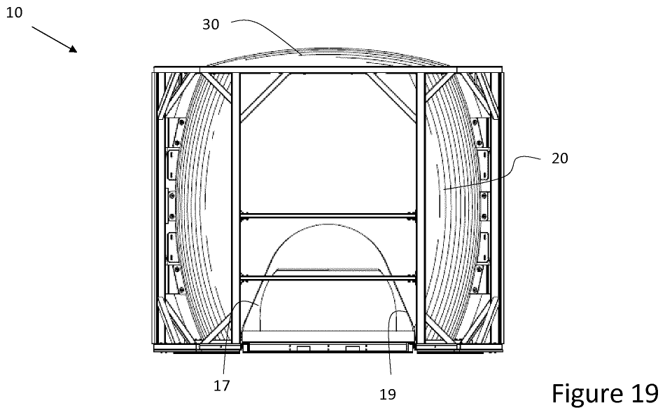

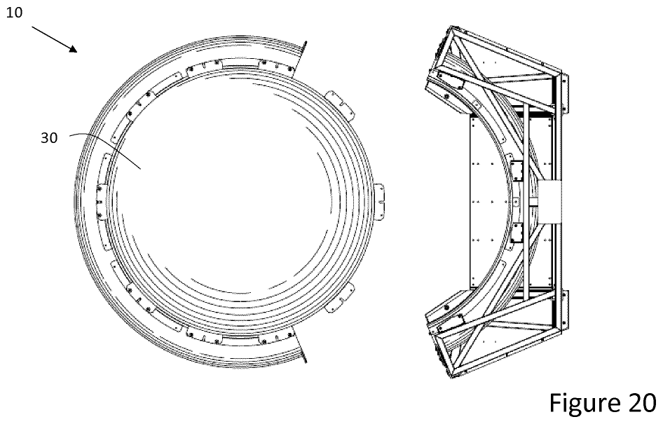

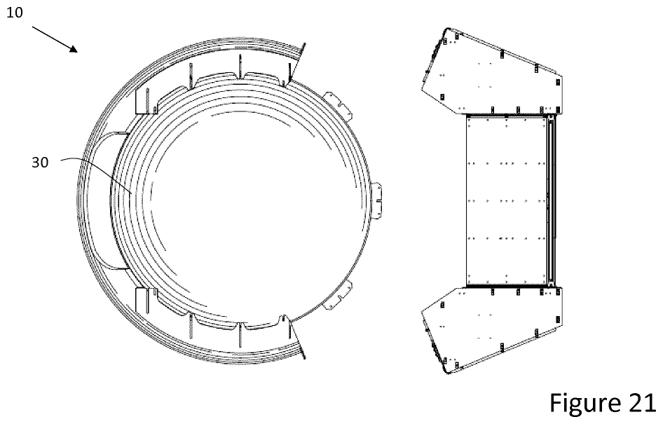

Referring to FIGS. 10 to 21, there is shown a rear projection dome 10 according to another embodiment of the present invention. This embodiment is substantially similar to the embodiment shown in FIGS. 1A to 9.

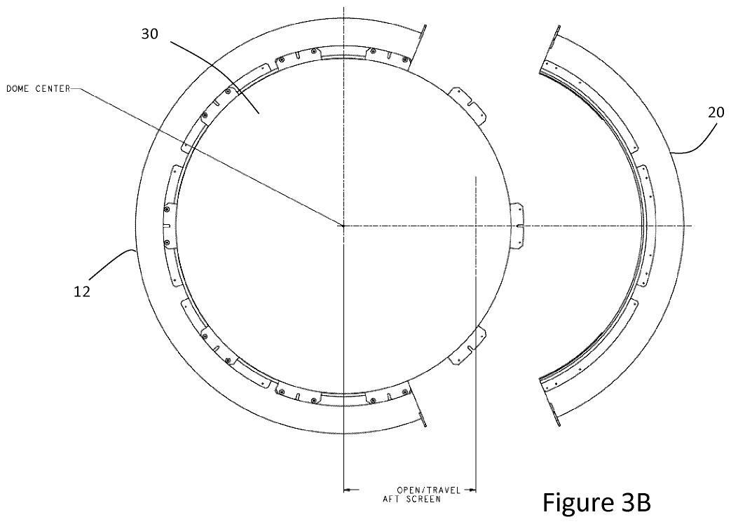

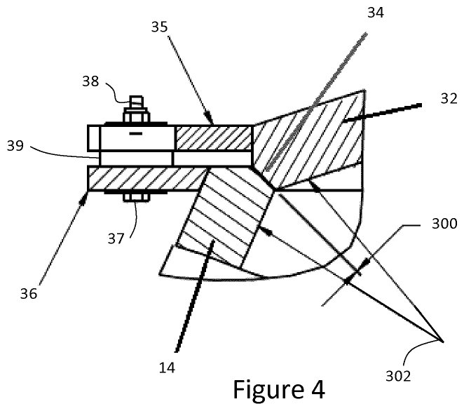

In embodiments, gaps 37 between adjacent lower flanges 36 of the front section 12, for example as shown in FIGS. 3A and 10, are removed to make the screen section 12 sturdier for shipping purposes. As such, the lower flanges 36 located above the front screen section 12 may form a single continuous flange that extends continuously along the upper front edge 14 of the front screen section 12 for connection with the flanges 35 located along the peripheral top edge 32 of the top screen section 30. Moreover, a rearmost flange may be removed as it could interfere with a top rear projector.

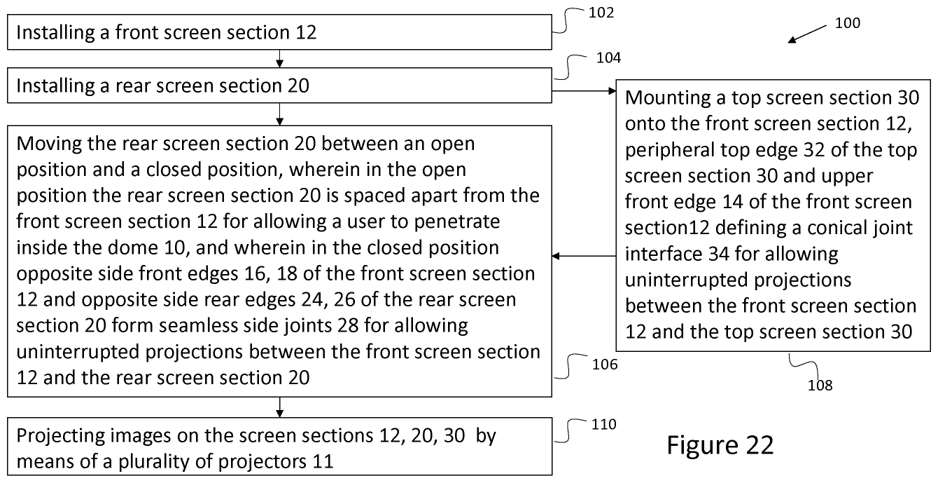

Referring now to FIG. 22, in addition to FIGS. 1 to 21, there is illustrated a method 100 for operating the rear projection dome 10, according a preferred embodiment of the present invention. The method 100 may include a step 102 of installing in place the front screen section 12 defining the upper front edge 14 and the opposite side front edges 16,18. The method 100 may include a step 104 of installing in place the rear screen section 20 defining the upper rear edge 22 and the opposite side rear edges 24, 26. The method 100 includes a step 106 of moving the rear screen section 20 between the open position and the closed position, wherein in the open position the rear screen section 20 is spaced apart from the front screen section 12 for allowing a user to penetrate inside the dome 10, and wherein in the closed position the opposite side front edges 16, 18 of the front screen section 12 and the opposite side rear edges 24, 26 of the rear screen section 20 form seamless side joints 28 for allowing uninterrupted projections between the front screen section 12 and the rear screen section 20.

The method 100 may include a step 108 of mounting the top screen section 30 onto the front screen section 12, the top screen section 30 defining a top peripheral edge 32 configured to be mounted to the upper front edge 14 of the front screen section 12, the peripheral top edge 32 of the top screen section 30 and the upper front edge 14 of the front screen section 12 defining a conical joint interface 34 for allowing uninterrupted projections between the front screen section 12 and the top screen section 30.

The method may include a step 110 of projecting images on the screen sections 12, 20, 30 by means of the plurality of projectors 11.

Advantages of some domes according to present embodiments is that these provide a 360-degree dome that is relatively easier access to a pilot cockpit and these provide 225 degrees forward and uninterrupted horizontal field of view (FOV), without having to disassemble most of the parts of the dome. In embodiments, the domes provide relatively easy installation and removal of a cockpit inside the dome.

The scope of the claims should not be limited by the preferred embodiments set forth in the examples but should be given the broadest interpretation consistent with the description as a whole.

1. A rear projection dome (10), comprising:
a front screen section (12) defining an upper front edge (14) and opposite side front edges (16,18);
a rear screen section (20) defining an upper rear edge (22) and opposite side rear edges (24, 26); and
a top screen section (30) defining a top peripheral edge (32) configured to be mounted to the upper front edge (14) of the front screen section (12);
wherein, when the top screen section (30) is mounted onto the front screen section (12), the peripheral top edge (32) of the top screen section (30) and the upper front edge (14) of the front screen section (12) define a conical joint interface (34) for allowing uninterrupted projections between the front screen section (12) and the top screen section (30).

2. The dome of claim 1, wherein the rear screen section (20) is configured to be moved between an open position and a closed position, wherein in the open position the rear screen section (20) is spaced apart from the front screen section (12) for allowing a user to penetrate inside the dome (10), and wherein in the closed position the opposite side front edges (16, 18) of the front screen section (12) and the opposite side rear edges (24, 26) of the rear screen section (20) form seamless side joints (28) for allowing uninterrupted projections between the front screen section (12) and the rear screen section (20).

3. The dome of claim 1, wherein the top peripheral edge (32) of the top screen section (30) is configured to be mounted to the upper rear edge (22) of the rear screen section (20), and wherein, when the top screen section (30) is mounted onto the rear screen section (20), the peripheral top edge (32) of the top screen section (30) and the upper rear edge (22) of the rear screen section (20) define a conical joint interface (40) for allowing uninterrupted projections between the rear screen section (20) and the top screen section (30).

4. The dome of claim 1, wherein the front screen section (12) and rear screen section (20) respectively define cutouts for accommodating a cockpit.

5. The dome of claim 1, further comprising a frame structure (23) for supporting the rear screen section (20), the frame structure (23) being configured to move the rear screen section (20) between the open and closed positions.

6. The dome of claim 1, further comprising:
a top flange (35) extending from the peripheral top edge (32) of the top screen section (30); and
a lower flange (36) extending from the upper front edge (14) of the front screen section (12);
wherein the peripheral top edge (32) of the top screen section (30) and the upper front edge (14) of the front screen section (12) that define the conical joint interface (34) are connectable together via a connection of the top flange (35) and lower flange (36).

7. The dome of claim 3, further comprising:
a top flange (45) extending from the peripheral top edge (32) of the top screen section (30); and
a lower flange (46) extending from the upper rear edge (22) of the rear screen section (20);
wherein the peripheral top edge (32) of the top screen section (30) and the upper rear edge (22) of the rear screen section (20) that define the conical joint interface (40) are connectable together via a connection of the top flange (45) and the lower flange (46).

8. The dome of claim 1, further comprising:
an upper flange (52) extending from the peripheral top edge (32) of the top screen section (30).

9. The dome of claim 8, further comprising:
a housing (60) configured for adjustable connection to the upper flange (52); and
an elongate member (56) having a bottom end pivotally connectable to a top end of the housing (60), the elongate member (56) having a top end pivotally connectable to an overhead frame (54) for operatively holding the top screen section (30).

10. The dome of claim 6, wherein the lower flange (36) extends continuously along the upper front edge (14) of the front screen section (12).

11. A rear projection dome system, comprising:
a plurality of projectors (11);
a front screen section (12) defining an upper front edge (14) and opposite side front edges (16,18);
a rear screen section (20) defining an upper rear edge (22) and opposite side rear edges (24, 26); and
a top screen section (30) defining a top peripheral edge (32) configured to be mounted to the upper front edge (14) of the front screen section (12);
wherein, in operation, the projectors cast images on the screen sections (12, 20, 30);
wherein, when the top screen section (30) is mounted onto the front screen section (12), the peripheral top edge (32) of the top screen section (30) and the upper front edge (14) of the front screen section (12) define a conical joint interface (34) for allowing uninterrupted projections between the front screen section (12) and the top screen section (30).

12. The dome system of claim 11, wherein the rear screen section (20) is configured to be moved between an open position and a closed position, wherein in the open position the rear screen section (20) is spaced apart from the front screen section (12) for allowing a user to penetrate inside the dome (10), and wherein in the closed position the opposite side front edges (16, 18) of the front screen section (12) and the opposite side rear edges (24, 26) of the rear screen section (20) form seamless side joints (28) for allowing uninterrupted projections between the front screen section (12) and the rear screen section (20).

13. The rear projection dome system of claim 11, wherein the top peripheral edge (32) of the top screen section (30) is configured to be mounted to the upper rear edge (22) of the rear screen section (20), and wherein, when the top screen section (30) is mounted onto the rear screen section (20), the peripheral top edge (32) of the top screen section (30) and the upper rear edge (22) of the rear screen section (20) define a conical joint interface (40) for allowing uninterrupted projections between the rear screen section (20) and the top screen section (30).

14. A method (100) for operating a rear projection dome (10) having a front screen section (12) and a rear screen section (20), said method comprising:
projecting projections that overlap between the front screen section (12) and the rear screen section (20), wherein opposite side front edges (16, 18) of the front screen section (12) and opposite side rear edges (24, 26) of the rear screen section (20) form seamless side joints (28) for allowing uninterrupted projections between the front screen section (12) and the rear screen section (20).

15. The method of claim 14, further comprising:
moving (106) the rear screen section (20) between an open position and a closed position, wherein in the open position the rear screen section (20) is spaced apart from the front screen section (12) for allowing a user to penetrate inside the dome (10), and wherein in the closed position said opposite side front edges (16, 18) of the front screen section (12) and said opposite side rear edges (24, 26) of the rear screen section (20) form seamless side joints (28) for allowing uninterrupted projections between the front screen section (12) and the rear screen section (20).

16. The method of claim 14, further comprising:
installing (102) in place said front screen section (12) defining an upper front edge (14) and said opposite side front edges (16,18); and
installing (104) in place said rear screen section (20) defining an upper rear edge (22) and said opposite side rear edges (24, 26).

17. The method of claim 14, further comprising mounting (108) a top screen section (30) onto the front screen section (12), the top screen section (30) defining a top peripheral edge (32) configured to be mounted to the upper front edge (14) of the front screen section (12), the peripheral top edge (32) of the top screen section (30) and the upper front edge (14) of the front screen section (12) defining a conical joint interface (34) for allowing uninterrupted projections between the front screen section (12) and the top screen section (30).

18. The method of claim 14, further comprising: projecting (110) images on said screen sections (12, 20) by means of a plurality of projectors (11).
